(19) United States
(12) Patent Application Publication
(10) Pub. No.: US 2008/0235935 A1
(43) Pub. Date: Oct. 2, 2008

(54) LAUNDRY TREATING APPARATUS

(76) Inventor: Dong Woo KANG, Changwon-si (KR)

Correspondence Address: KED & ASSOCIATES, LLP, P.O. Box 221200, Chantilly, VA, 20153-1200, US

(21) Appl. No.: 12/042,603

(22) Filed: Mar. 5, 2008

(30) Foreign Application Priority Data
Mar. 6, 2007 (KR) 10-2007-0021920
Mar. 6, 2007 (KR) 10-2007-0021921
Mar. 6, 2007 (KR) 10-2007-0021922
Mar. 6, 2007 (KR) 10-2007-0021923
Mar. 6, 2007 (KR) 10-2007-0021924
Mar. 6, 2007 (KR) 10-2007-0021925
Jan. 10, 2008 (KR) 10-2008-0002963
Jan. 10, 2008 (KR) 10-2008-0002965
Jan. 10, 2008 (KR) 10-2008-0002966

(51) Int. Cl. B23P 17/00; B65D 6/00

(52) U.S. Cl. 29/592; 220/660

(57) ABSTRACT

A laundry treating apparatus is provided which can be manufactured easily. The laundry treating apparatus manufacturing method includes providing a metal plate formed of stainless steel and drawing the stainless steel plate to form a front panel such that the front panel includes a front surface and a plurality of edges extending continuously therefrom and at least one seamless corner where the front surface and two of the plurality of edges meet.

This application claims priority to Korean Patent Application No. 10-2000-2007-0021924 and 10-2007-0021925, filed on Mar. 6, 2007, and 10-2008-0002966 filed on Jan. 10, 2008, in Korea, which is hereby incorporated by reference in its entirety.

### BACKGROUND

1. Field

A laundry treating apparatus is disclosed herein.

2. Background

Landry treating apparatuses are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is an exploded perspective view showing assembly of a laundry treating apparatus according to an embodiment;

FIG. 2 is a front perspective view of a laundry treating apparatus according to an embodiment;

FIG. 3 is a front perspective view of the front cover of the laundry treating apparatus of FIG. 2;

FIG. 4 is a rear perspective view of the front cover of FIG. 3;

FIG. 5 is a table illustrating properties of stainless steel that belong to STS 300;

FIG. 6 is a perspective view illustrating sample pieces fabricated from stainless steel;

FIG. 7 is a graph illustrating degrees of spring back for the samples of FIG. 6;

FIG. 8 is a perspective view of a stainless steel plate having a door opening formed therein;

FIG. 9 is a perspective view of the stainless steel plate of FIG. 8 after a drawing process;

FIG. 10 is a perspective view of the stainless steel plate of FIG. 9 showing a stepped portion formed along a circumference of the stainless steel plate; and

FIG. 11 is a perspective view of the stainless steel of FIG. 10 showing an area for various accessories to be secured formed thereon.

### DETAILED DESCRIPTION

Reference will now be made in detail to embodiments, examples of which are illustrated in the accompanying drawings. Wherever possible, like reference numbers have been used throughout the drawings to refer to the same or like parts. In the present application, embodiments are disclosed using a washer as an exemplary laundry treating apparatus for explanatory purposes; however, embodiments may also be applicable to a dyer and a laundry machine having a washing and drying function.

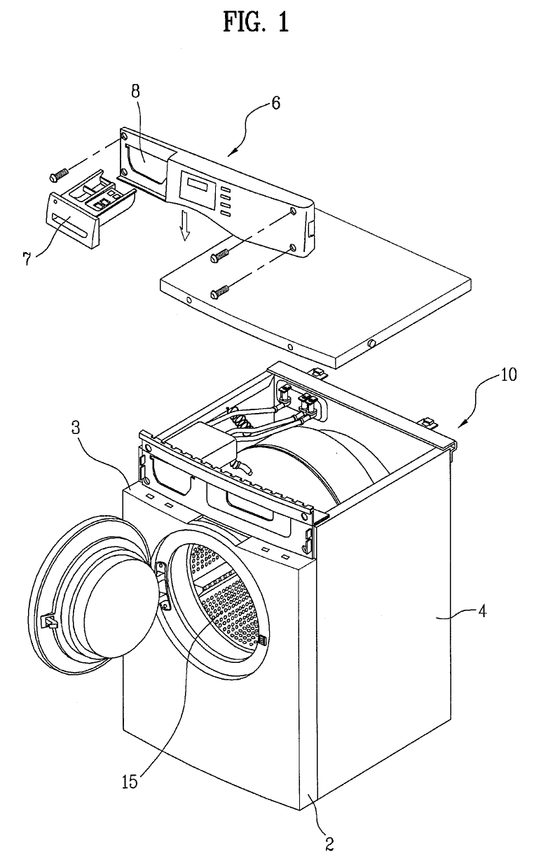

Laundry treating apparatuses are generally electric appliances including washers, dryers, and combined laundry treating apparatus having both washing and drying functions that can wash and/or dry laundry, such as clothes, cloth items, beddings, and similar items. FIG. 1 is an exploded perspective view showing assembly of a drum type washer 10 having a control panel 6 mounted on a front cover 2. A tub 15 is first mounted between side surfaces 4, and a front cover 2 is then coupled to the side surfaces 4 to define the front surface of the drum type washer 10. A control panel 6 is mounted in a recess part 3 formed in an upper portion of the front cover 2. That is, in this washer, the front cover 2 is installed first and the auxiliary control panel 6 is mounted additionally. A detergent box 7 is retractable through an opening 8 formed in the control panel 6.

However, the assembly time of such a drum type washer is increased, because the control panel 6 is separate from the front cover and must be separately installed. That is, the front cover 2 and the control panel 6 must be assembled separately.

Moreover, the front cover is commonly formed of steel in such a drum type washer. After molding the front cover into an appropriate shape, a coating process is performed to prevent corrosion. As a result, after the steel molding process, the coating process must be performed for such a drum type washer.

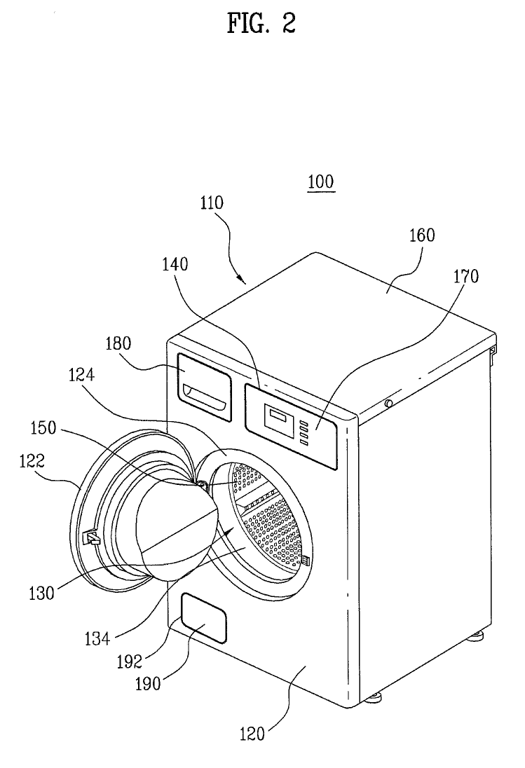

FIG. 2 is a perspective view of a laundry treating apparatus according to an embodiment. The laundry treating apparatus of FIG. 2 includes a washer 100 that may include a cabinet 110, a drum 150, and a front cover 120. The cabinet 110 may define an exterior appearance of the washer 100. The drum 150 may be rotatable in the cabinet 110 and laundry may be held in the drum 150. The front cover 120 may define a front surface of the cabinet 100.

A front portion of the cabinet 110 may be opened and the opened portion covered by the front cover 120. Alternatively, a front part (not shown) of the cabinet 110 may be formed in advance and the front cover 120 may be additionally secured to the front part (not shown) of the cabinet 110. In this embodiment, the front portion of the cabinet 110 is formed open and the opened portion is covered by the front cover 120.

As set forth above, the cabinet 110 may define the exterior appearance of the washer 100, and the drum 150 and a tub (not shown) may be provided in the cabinet 110. The front portion of the cabinet 120 may be opened and covered by the front cover 120, which will be described in detail herein below, and an upper portion of the cabinet 110 may be covered by an upper cover 160. Further, the front cover 120 may be secured to the opened front portion. The front cover 120 may be molded by drawing a stainless plate, which will be described in detail herein below.

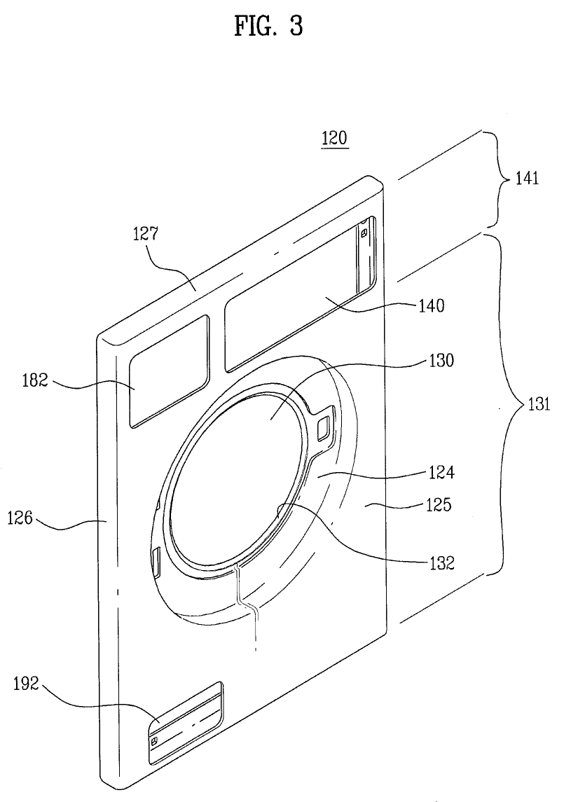

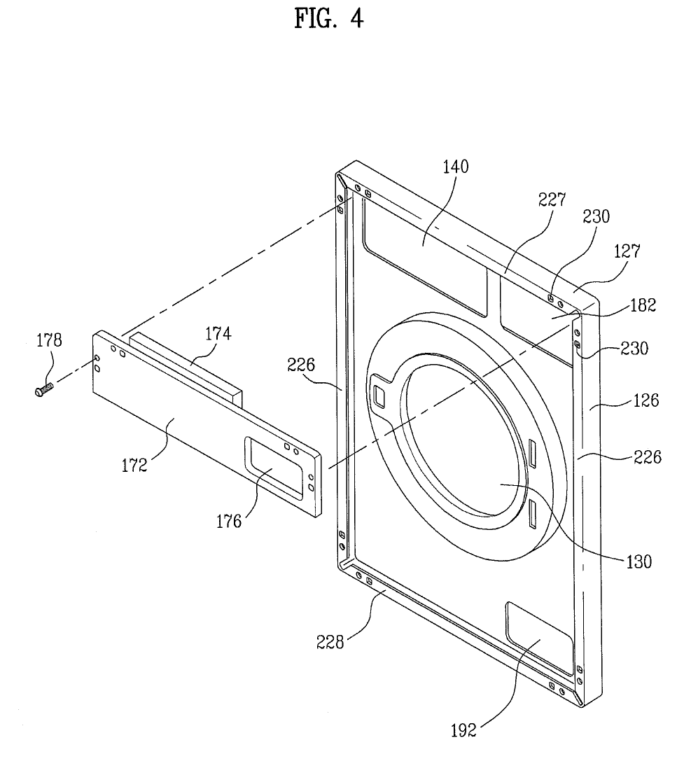

FIG. 3 is a front perspective view of the front cover of FIG. 2, after separating the front cover from the washer. FIG. 4 is a rear perspective view of the front cover of FIG. 3.

Referring to FIG. 3, the front cover 120 may include a front surface 125 and at least one side surface 126 which may be formed continuously from the front surface 125. The front surface 125 may include a door opening 130 and a control panel opening 140. A door 122 (see FIG. 2) may be coupled to the door opening 130 and a control panel 170 (see FIG. 2) may be coupled to the control panel opening 140. Although it is shown in the drawings that the control panel opening 140 and the door opening 130 are both formed in the front cover 120, embodiments should not be so limited. For example, only the door opening may be formed in the front cover 120 and the control panel 170 may be mounted to an upper portion of the front cover 120. However, this embodiment shows the control panel opening 140 and the door opening 130 both formed in the front cover 120.

Further, as shown in FIG. 3, the control panel opening 140 may be formed above the door opening 130. However, in alternative embodiments, the control panel opening 140 may be formed below the door opening 130.

The door opening 130 may be formed in a recessed part 124 formed in the front surface 125. That is, the door opening 130 may be directly formed in the front surface 125, or the recessed part 124 may be formed in the front surface 125 and the door opening 130 formed at a center of the recessed part 124. The recessed part 124 may be a predetermined space configured to receive the door 122 rotatably coupled to the door opening 130. As a result, when a user closes the door 122, the door 122 may be received into the recessed part 124 and not project beyond the front surface 125.

A gasket 134 (see FIG. 2) may be connected to the door opening 130 to prevent water inside the drum 150 and the tub (not shown) from leaking into the cabinet 110. A connection part 132 may extend along an inner circumference of the door opening 130 for the gasket 134 to be connected thereto.

At least one side surface 126 may be formed from the front surface 125 continuously as one body with the front surface 125. Moreover, a pair of side surfaces 126 may be formed at both opposite sides of the front surface 125, as shown in FIG. 3. The expression “the side surface is formed continuously from the front surface” means that the side and front surfaces are formed as a single member. The expression “formed continuously” does not mean that the front surface and the side surface are connected by welding. That is, the expression “formed continuously” means that the side surface and the front surface are formed as the single member without a ‘seam’ formed by welding.

As shown in FIG. 3, when the panel opening 140 is formed above the door opening 130, the front surface 125 may be divided into a control panel area 141 in which the control panel opening 140 may be formed and a door area 131 in which the door opening 130 may be formed. That is, an upper area of the front surface 125 may be the control panel area 141 and a lower area of the front surface 125 may be the door area 131, with respect to a center of a portion between the door opening 130 and the control panel opening 140. In this case, the side surface 126 may be formed extending from each of the front portion of the control panel area 141 and the door area 131. Further, the side surfaces 126 of the control panel area 141 and the door panel 131 may be formed continuously. That is, the side surfaces 126 continuously formed from the control panel area 141 and the door area 131 may be formed continuously from each other.

In addition, the front surface 125 of the front cover 120 may further include an upper surface 127 and a lower surface (not shown) continuously formed from the front surface 125, respectively. Either of the upper surface 127 and the lower surface may be continuously formed from the front surface 125, or both the upper surface 127 and the lower surface may be continuously formed from the front surface 125.

As shown in FIG. 4, an upper flange part 227, a side flange part 226 and a lower flange part 228 may be formed at the upper surface 127, the side surface 126, and the lower surface, respectively. Each of the flange parts 226, 227 and 228 may be utilized to secure the front cover 120 to the cabinet 110, and may also be used to mount the control panel 170.

The upper flange part 227 and the lower flange part 228 may extend continuously from the upper surface 127 and the lower surface (not shown), respectively. Further, the upper flange part 227 and the lower flange part may not be continuously formed with the side flange part 226. As shown in FIG. 4, while the upper surface 127, side surface 126, and the lower surface (not shown) may be continuously formed from each other, the upper flange part 227 continuously formed from the upper surface 127, the side flange part 226 continuously formed from the side surface 126, and the lower flange part 228 continuously formed from the lower surface may not be continuously formed from each other but separately formed.

The upper surface 127, the side surface 126, and the lower surface (not shown) may be continuously formed from each other, because they are exposed outside as a part of an exterior of the washer 100. However, the flange parts do not have to be continuously formed from each other, because they are positioned within the cabinet 110 and are not exposed to the outside.

In addition, at least one coupling hole 230 may be formed in each of the flange parts 226, 227 and 228 for the front cover 120 to be connected with the cabinet 110 and for the control panel 170 to be mounted thereto.

As discussed, with the above configuration either the upper surface 127 and/or the lower surface may be continuously formed from the front surface 125. If only the upper surface 127 is continuously formed from the front surface 125, the upper surface 127 and the side surfaces 126 may be continuously formed from each other. In this case, the flange parts 227 and 226 extending from the upper surface 127 and the side surface 126, respectively, may not be continuously formed from each other but formed separately. Alternatively, only the lower surface may be continuously formed from the front surface 125.

The control panel 170 may be mounted to the front cover 120 to form a single module. That is, the front cover 120 having the control panel 170 mounted thereto may be assembled, which enables assembly workers to assemble a washer more easily with less assembly processes.

More specifically, the control panel 170 may include a mounting plate 172 detachably coupled to the flange parts 227 and 226 and at least one selection part 174 mounted on the mounting plate 172 to be exposed to the outside through at least one control panel opening 140. The mounting plate 172 may be detachably connected to the upper flange part 227 and the side flange part 226. A plurality of coupling holes may be formed in the upper flange part 227 and the side flange part 226, and the mounting plate 172 may be coupled to the flange parts 227 and 226 by at least one coupling member, such as a bolt 178. Although not shown in the drawings, if the control panel opening 140 is formed below the door opening 130, the mounting plate 172 may be coupled to the side flange part 226 and the lower flange part 228.

As mentioned above, at least one selection part 174 may be mounted on the mounting plate 172. The selection part 174 may be detachable. For example, the selection part 174 may be mounted to the mounting plate 172 by a securing device, such as a hook (not shown) or a bolt (not shown). However, the selection part 174 may be mounted to the mounting plate 170 by other means as well. The selection part 174 may be exposed to the outside through the control panel opening 140 formed in the front surface 125 and a user may operate the selection part 174 to control an operation of the washer 100.

Although not shown in the drawings, a user may operate selection buttons provided on the selection part 174 to select a washing course or to adjust a water amount, a washing time, a rinsing number, a rinsing time, a spin-drying time based on the selected washing course and a steam spray point, and a steam amount when selecting steam spray. The selection buttons provided on the selection part 174 are merely examples and may be varied with other types of input devices.

In addition to the control panel opening 140 and the door opening 130, a detergent box opening 182 may be formed in the front surface 125 of the front cover 120 and a detergent box 180 (see FIG. 2) may be mounted in the detergent box opening 182. The detergent box opening 182 may be formed at a predetermined portion of the front surface 125 adjacent to the control panel opening 140; however, other positions may also be appropriate. Moreover, the detergent box 180 may be retractably installed in an opening 176 of the mounting plate 172 through the detergent box opening 182. Detergent, fabric softener, and wash water may all be supplied through the detergent box 180 similar to a conventional washer, and thus, detailed description thereof will be omitted.

Reference numeral 192 designate a service hole in FIGS. 3 and 4. The service hole 192 may be formed at a lower portion of the front surface 125 and may be covered by a service hole cover 190 (see FIG. 2). If maintenance and repair of the washer is needed, a service person may perform a maintenance/repair job in the washer through the service hole 192. That is, a service person may separate the service hole cover 190 from the service hole 192 to perform maintenance and repair of elements inside the washer.

The front cover 120 having the above configuration may be fabricated with a metal having an original metal gloss and color. In particular, the front cover 120 may be fabricated with stainless steel. Since the washer 100 has frequent contact with water, the front cover 120 may be fabricated with stainless steel having an original metal gloss and color and which will not easily corrode without a coating.

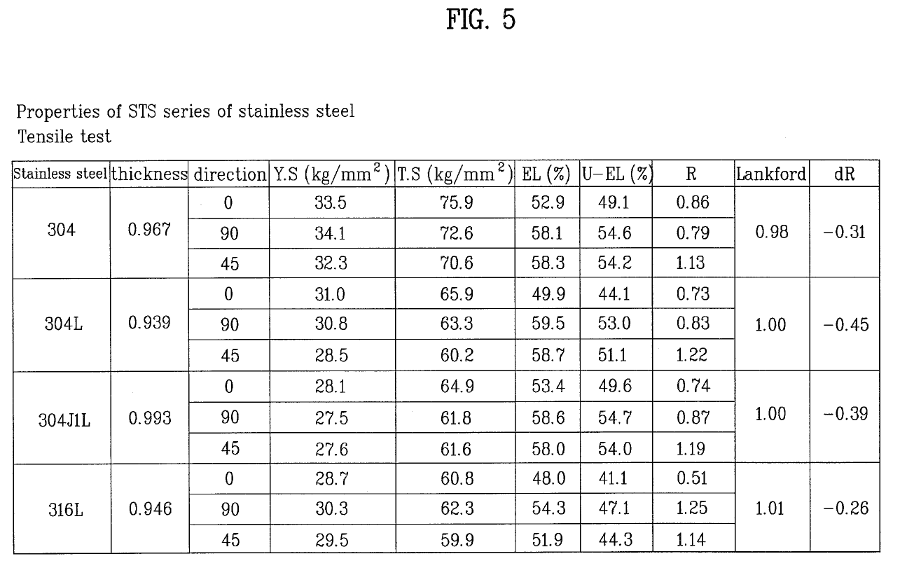

To improve a manufacturing process of a front cover manufactured using a drawing process, properties of various stainless steel series have been researched and the STS 300 series of stainless steel selected. FIG. 5 is a table illustrating properties of a STS series of stainless steel, specifically, properties of STS 304, STS 304L, and STS 304J1.

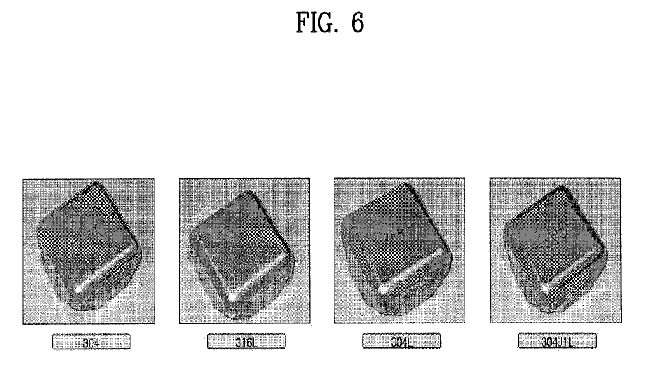

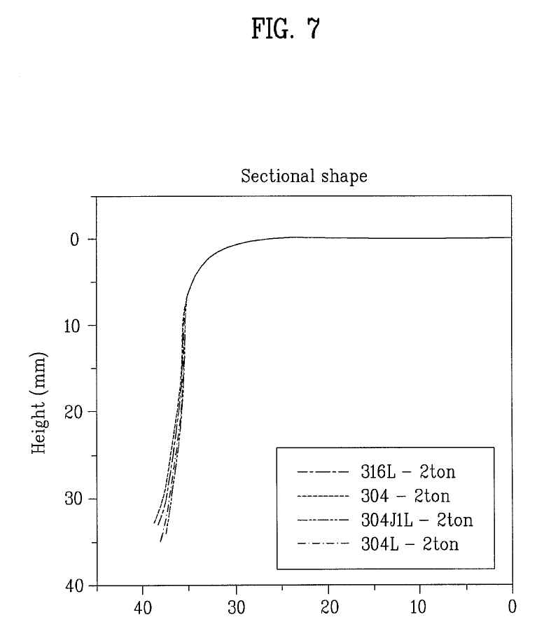

As there may be a work hardening of stainless steel, the STS 300 series of stainless steel has been drawn and sample pieces made as shown in FIG. 6 to examine degrees of spring back of the sample pieces. A graph shown in FIG. 7 has been made and the results analyzed. The spring back of STS 304J1 stainless steel was found to be smallest in the STS series of stainless steel, and thus, selected.

Next, a method of manufacturing a front cover using a stainless steel plate according to an embodiment will be explained herein below. Recently, there have been increasing demands for electric appliances, such as laundry treating apparatuses that have exterior beauty with a unique metal color and gloss. One example of a material having a unique metal color and gloss is stainless steel. However, if front covers of laundry treating apparatuses are manufactured using stainless steel, it is difficult to manufacture the front covers in desired shapes.

When drawing stainless steel, there is a severe work hardening, and thus, it is difficult to perform repeated drawing processes with stainless steel. As a result, the drawing process should be performed once and a desired shape fabricated, which is difficult. In addition, stainless steel has a large spring back phenomena, and thus, it is difficult to manufacture a desired shaped stainless steel having a desired size, using the drawing process.

The manufacturing method according to embodiments disclosed herein provide a method of manufacturing a front cover using stainless steel having a unique metal color and gloss. In the manufacturing method according to embodiments disclosed herein, the drawing process is performed only one time to manufacture the front cover and it includes a process to reduce the spring back of stainless steel created after the drawing process. With reference to the drawings, the method of manufacturing the front cover according to an embodiment will be explained in detail herein below.

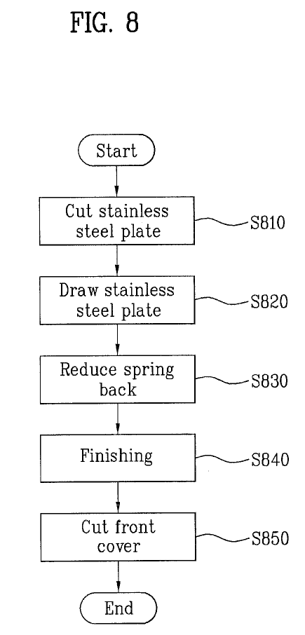

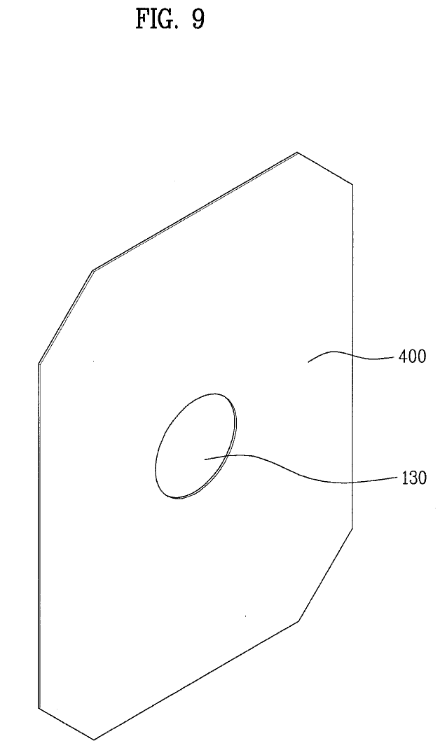

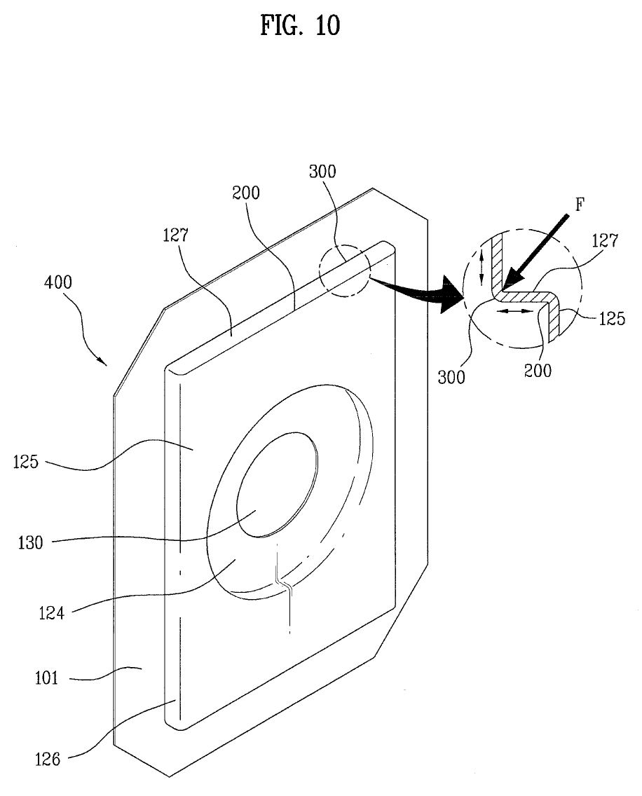

The method of manufacturing a front cover according to an embodiment disclosed herein will be discussed with reference to FIGS. 8-12, and includes a drawing step, a spring back reducing step, and a cutting step. In the drawing step, a stainless plate, such as that shown in FIG. 9, is drawn.

First, a worker cuts a stainless steel sheet in an appropriate length and height to form a stainless plate 400, in step S810. In this step, a worker may form a door opening 130 in the stainless plate 400 for a door to be coupled to the door opening 130. The door opening 130 may be formed at a center of the stainless plate 400. Further, a worker may chamfer corners of the stainless plate 400 to prevent injuries to workers during the following processes and to facilitate the manufacturing processes.

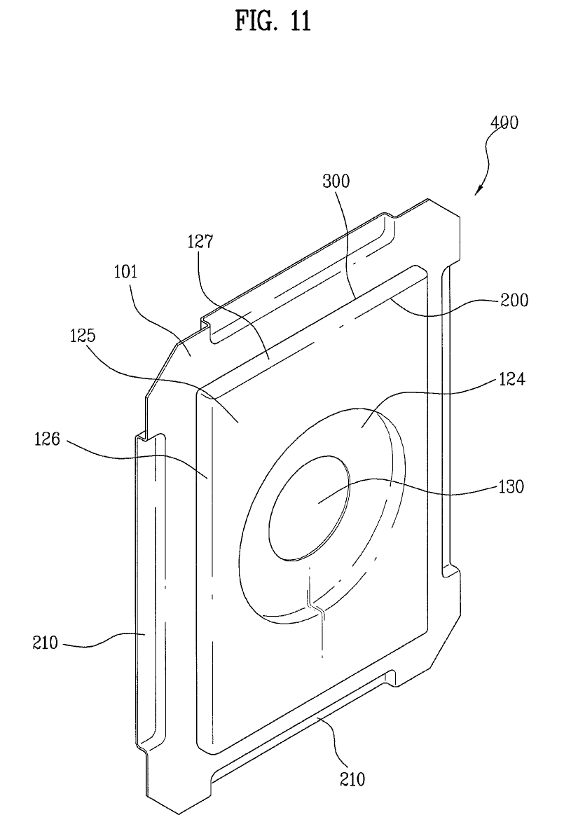

Next, a worker draws the stainless steel plate, in step S820. As shown in FIG. 10, the worker may draw the stainless plate to form a front surface 125 and side surfaces 126 and 127. Here, the side surfaces 126 and 127 mean an upper surface 127 and a lower surface (not shown) formed at upper and lower portions of the front surface 125, as well as side surfaces 126 formed at both side portions of the front surface 125, as viewed from a front of the front surface 125.

A recess part 124 may be formed at the door opening 130 to receive the door therein. The recess part 124 may be formed in the drawing step. In the drawing step, the recess part 124 may be formed along an outer circumference of the door opening 130, together when forming the front surface 125 and the side surfaces 126 and 127 of the front cover 120.

The drawing step to form the front cover according to this embodiment is performed one time, because of the severe work hardening of stainless as mentioned above. Since the work hardening of stainless is more severe after repeated drawing processes, the drawing is performed only one time and a desired shape is formed.

After drawing the stainless steel plate, a worker reduces a spring back of the drawn stainless steel plate, in step S830. Stainless steel has an unique metal color and gloss but it has a spring back phenomenon. Because of this characteristic of stainless steel, it is difficult to manufacture a desired shaped stainless steel panel. Thus, a desired shaped panel of stainless steel should be formed in one drawing process because of the work hardening, and a desired shaped stainless steel panel with a desired size should be manufactured by reducing the spring back.

In the method of manufacturing according to this embodiment, to reduce a spring back acting between a first connection 200 and a second connection 300, a stress in a longitudinal direction of the side surfaces 126 and 127, in other words, a stress in a vertical direction of the front surface 125 is the dominant of two stresses acting in two different directions between the connections 200 and 300. The first connection 200 is bent between the front surface 125 and the side surfaces 126 and 127. The second connection 300 is bent between the side surfaces 126 and 127 and the plate edge portions. The word “dominant” means that the stress acting in a longitudinal direction of the side surfaces 126 and 127 is larger, for example, at least approximately twice as large, as the stress acting in the other direction.

The drawing process may be performed when molding a curved shape and a spring back generated by stresses acting in different directions at the bent portions. It is difficult to reduce a spring back in the drawing process, compared with molding a simple linear shape. When drawing the front surface 125 and the side surface 126 and 127, there may be a bent portion between the side surface 126 and the upper side surface 127 and a bent portion between the side surface 126 and the lower side surface (not shown) and complex stresses may be activated at the bent portions of the side surfaces 126 and 127. Especially, nearer to the bent portions between the side surface 126 and the upper surface 127 and between the side surface 126 and the lower surface (not shown), a lot of complex stresses may be activated.

The stress acting in a longitudinal direction of the side surfaces 126 and 127 is dominant over the other stresses acting in different directions of the bent portions, especially, one of the stresses acting in a width direction of the side surfaces 126 and 127. That is, the stress in a longitudinal direction of the side surface 126 and 127 may be, for example, at least approximately twice as large as the other stress in a width direction of the side surface 126 and 127. If the stress in a longitudinal direction is dominant, the complex stress may not be activated and the spring back reduced. That is, only the stress acting in the longitudinal direction of the side surfaces 126 and 127 out of the plurality of stresses acting at the bent portions may remain as a main stress and the spring back may be reduced.

More specifically, to make dominant the stress acting in a longitudinal direction of the side surface 126 and 127 out of the plurality of stresses at the bent portions, the side surfaces 126 and 127 may be expanded or elongated a predetermined length. The stress in the longitudinal direction may be dominant over the other stresses by expanding or elongating the side surfaces 126 and 127 a predetermined length.

A predetermined force is applied to expand the length of the side surfaces 126 and 127. At this time, if the plate 400 is not fixed, the plate edge portion 101 moves toward the side surfaces 126 and 127. As a result, the expansion of the side surfaces 126 and 127 is not performed as much as desired. Thus, if expanding or elongating the side surface 126 and 127, the plate edge portion 101 corresponding to the side surface 126 and 127 may also be expanded or elongated. That is, both side surfaces 126 and 127 and corresponding plate edge portions 101 with respect to the second connection 300 may be expanded or elongated, respectively, without moving material of the plate 400 with respect to the second connection 300 bent between the side surfaces 126 and 127 and the plate 400.

To expand the side surfaces 126 and 127 and the plate edge portion 101, a worker may fix the plate edge portion 101 and apply a predetermined force (F) to the second connection 300 bent between the side surfaces 126 and 127 and the plate 400. The predetermined force may be applied using, for example, a die specifically configured to provide an appropriate force to expand or elongate the side surfaces 126 and 127 and the corresponding plate edge portion 101 an appropriate amount in an appropriate direction. Hence, the side surfaces 126 and 127 and the corresponding plate edge portions 101 may be expanded or elongated in an arrow direction with respect to the second connection 300 by the force (F) acting at the second connection and the plate edge portion 101 fixed not to move toward the second connection 300.

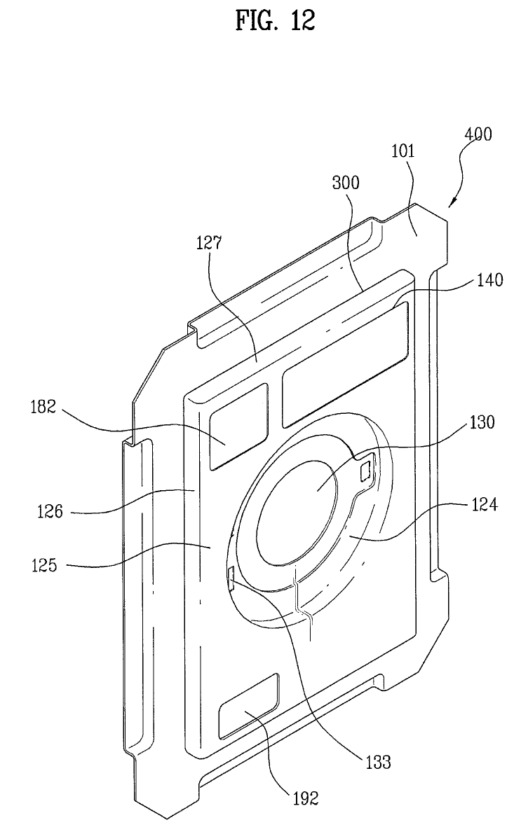

As shown in FIG. 11, before applying the force to the second connection 300, at least one stepped portion 210 may be formed along the plate edge portion 101 to prevent the plate edge portion 101 from moving toward the bent second connection 300. The stepped portion 210 may be formed along the plate edge portion 101 a predetermined length. In this embodiment, after the drawing step, the side surfaces 126 and 127 and the plate edge portions 101 may be expanded or elongated in both opposite directions with respect to the second connection 300 to reduce the spring back.

After the spring back reducing step, a worker may form an area for, for example, a control panel, a door, and a service hole cover in a finishing step, step S840. FIG. 12 illustrates a plate in which an area for each of a control panel, a door, and a service hole cover have been formed. Referring to FIG. 12, the control panel opening 140 may be formed above the door opening 130 and the control panel (not shown) mounted in the control panel opening 140. In addition, a service hole 192 may be formed below the door opening 130 and the service hole cover (not shown) mounted in the service hole 192. When performing maintenance and repair of a washer, a service person may perform a maintenance and repair job inside the washer through the service hole 192. Also, a coupling part 133 may be formed in the recess part 124 of the door opening 130.

Finally, a worker may cut a front cover 120 (see FIG. 3) from the stainless plate 400, in step S850. When cutting the front cover 120, a worker may cut along the second connection 300 connected between the side surfaces 126 and 127 and the plate edge portion 101. A worker may cut enough of a portion to form the flange parts 226, 227 and 228 (see FIG. 4). That is, the cut front cover 120 may have an enough section in a predetermined length to form the flange parts 226, 227 and 228 along edges of the side surfaces 126 and 127. As a result, the flange parts 226, 227 and 228 may not be continuously formed from each other but separately formed, as shown in FIG. 4, although the flange parts 226, 227 and 228 may be continuously formed from the side surfaces 126 and 127.

After cutting the front cover 120 from the stainless plate 400, the worker may form the flanges by bending the flange parts 226, 227 and 228. The front cover 120 may be coupled to the cabinet of the washer using the flanges. That is, a worker may couple the front cover to the cabinet using the flanges.

Embodiments disclosed herein provide a laundry treating apparatus capable of being manufactured easily by reducing the required processes.

A laundry treating apparatus according to one embodiment is provided that includes a front cover including a front surface formed from a stainless plate by a drawing process and at least one side surface having a predetermined length continuously formed from the front surface. The drawing process may be performed one time, because there is a work hardening of a stainless plate.

The front cover may include a pair of side surfaces continuously formed from the front surface. The front cover may further include an upper surface continuously formed from the front surface. The upper surface may be continuously formed from the pair of the side surfaces. The pair of the side surfaces and the upper surface may include a pair of side flange parts and an upper flange part, respectively, and each of the flange parts may be formed separately.

The front cover may further include a lower surface continuously formed from the front surface. The lower surface may be continuously formed from the pair of the side surfaces. The pair of the side surfaces and the lower surface may include a pair of flange parts and a lower flange part, respectively, and each of the flange parts may be formed separately.

The front cover may further include an upper surface and a lower surface continuously formed from the front surface. Both of the upper surface and the lower surface may be continuously formed from the pair of the side surfaces. The upper surface, the pair of the side surfaces, and the lower surface may include an upper flange part, a pair of side flanges and a lower flange part, respectively, and each of the flange parts is formed separately.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for manufacturing a front panel for a laundry treating apparatus, the method comprising:
providing a metal plate formed of stainless steel; and
drawing the stainless steel plate to form a front panel such that the front panel includes a front surface and a plurality of side surfaces extending continuously therefrom and at least one seamless corner where the front surface and two of the plurality of side surfaces meet.

2. The method of claim 1, wherein the stainless steel comprises STS 304J1.

3. The method of claim 1, further comprising forming an opening for a door in the stainless steel plate.

4. The method of claim 3, wherein forming the opening for the door in the stainless steel plate is performed prior to drawing the stainless steel plate.

5. The method of claim 3, further comprising forming an opening for a control panel in the stainless steel plate.

6. The method of claim 5, wherein the opening for the control panel is formed above the opening for the door.

7. The method of claim 3, wherein drawing the stainless steel plate further comprises recessing the opening for the door.

8. The method of claim 1, wherein the at least one seamless corner comprises at least two seamless corners.

9. The method of claim 8, wherein the at least one seamless corner comprises a seamless corner formed at each corner where the front surface and two of the plurality of side surfaces meet.

10. The method of claim 1, wherein the at least one seamless corner is not formed by a joining process.

11. The method of claim 10, wherein the at least one seamless corner is not formed by welding.

12. The method of claim 1, wherein the plurality of side surfaces comprise top, bottom, left, and right side surfaces.

13. The method of claim 1, further comprising forming an opening for a detergent box.

14. The method of claim 1, further comprising forming at least one service opening.

15. The method of claim 1, further comprising forming a plurality of flanges extending continuously from respective ones of the plurality of side surfaces.

16. The method of claim 15, wherein the plurality of flanges do not connect to one another.

17. The method of claim 1, further comprising performing a spring back preventing method on at least one of the plurality of side surfaces.

18. The method of claim 16, wherein the spring back preventing method comprises elongating at least one of the plurality of side surfaces.

19. A front panel for a laundry treating apparatus formed by the method of claim 1.

20. A method for manufacturing a front panel for a laundry treating apparatus, the method comprising:
providing a metal plate formed of stainless steel; and
drawing the stainless steel plate to form a front panel having at least three continuously formed surfaces that are oriented substantially perpendicular to one another.
